(19) United States
(12) Patent Application Publication
(10) Pub. No.: US 2006/0076319 A1
(43) Pub. Date: Apr. 13, 2006

(54) Arc welding apparatus

(75) Inventors: David P. Pace, Idaho Falls, ID (US); Rodney J. Bitsoi, Ririe, ID (US); Arthur D. Watkins, Idaho Falls, ID (US)

Correspondence Address: Alan D. Kirsch, P.O. Box 1625, Idaho Falls, ID, 83415-3899, US

(73) Assignee: Bechtel BWXT Idaho, LLC

(21) Appl. No.: 10/961,550

(22) Filed: Oct. 7, 2004

(51) Int. Cl. B23K 9/167

(52) U.S. Cl. 219/75

(57) ABSTRACT

An arc welding apparatus is disclosed, and which includes a torch body which is coupled with a source of electrical power; an electrode having a proximal end which is borne by the torch body and which is electrically coupled with the source of electrical power, and an opposite distal end; and a gas cup which matingly cooperates with the torch body and which is selectively moveable relative to the distal end of the electrode.

### GOVERNMENT RIGHTS

The United States Government has rights in the following invention pursuant to Contract No. DE-AC07-99ID13727 between the U.S. Department of Energy and Bechtel BWXT Idaho, LLC.

### TECHNICAL FIELD

The present invention relates to an arc welding apparatus, and more specifically to an arc welding apparatus which can be readily adjusted and operated remotely.

### BACKGROUND OF THE INVENTION

The prior art is replete with numerous examples of gas tungsten arc welding apparatuses which are useful for welding various metal substrates. An example of a prior art gas tungsten arc welding torch apparatus is seen in U.S. Pat. Nos. 5,481,079 and 3,803,381, the teachings of which are incorporated by reference herein. While various gas tungsten arc welding devices of assorted designs have operated with a high degree of success through the years, there are shortcomings which are inherent in their individual designs which prohibit them from being successfully utilized in certain environments. For example, the nuclear industry has long struggled with issues surrounding the handling and the disposal of nuclear waste. Typically, in this industry segment, hazardous waste such as nuclear waste is typically sealed in metal containers for long storage and to prevent such materials from escaping into the immediate ambient environment. Heretofore, canisters or containers of this type were sealed by personnel in environments called “hot cells”, that is, rooms having thick walls and windows where work can be safely done with radioactive materials that might be detrimental to humans. Notwithstanding the safeguards that have been developed, the present system for handling nuclear waste and sealing the same in such containers by welding them closed has been less than ideal. For example, in this particular industry segment, such welding operations which have been conducted in “hot cells” are typically done remotely, and are controlled robotically. In this robotically controlled environment, the weld that is being formed is viewed by means of a camera which is focused on the weld and more specifically on the distal end of the electrode which forms a portion of the gas tungsten arc welder. In these welding operations, it is often necessary to change the distance that the distal end of the electrode extends past the corresponding gas cup in order to fill the weld effectively. As should be understood, when operating remotely, any camera which is focused on the distal electrode tip must be correspondingly adjusted any time this distance changes.

In addition to the above identified difficulty, prior art gas tungsten arc welding torches typically require complex manipulation in order to remove a dull tungsten electrode, and replace it with a freshly ground electrode. In addition to the foregoing, commercially available gas tungsten arc welders which have been utilized heretofore, have limited duty cycles, unless they are equipped with supplemental cooling. In the situation where such gas tungsten arc welders are utilized in a “hot cell” arrangement, water cooled prior art arc welders are not desirable inasmuch as a leakage of water from such an arc welders would require that the contaminated water then be collected for further disposal. Further, the use of water cooled arc welding torches have additional safety concerns regarding the criticality of the fuel employed with same. The continuous duty cycles of such air cooled gas tungsten arc welders have typically been less than about 150 amps.

An arc welding apparatus which addresses these and other shortcomings in the prior art apparatuses is the subject matter of the present invention.

### SUMMARY OF THE INVENTION

A first aspect of the present invention relates to an arc welding apparatus which includes a torch body which is coupled with a source of electrical power; an electrode having a proximal end which is borne by the torch body and which is electrically coupled with the source of electrical power, and an opposite distal end; and a gas cup which matingly cooperates with the torch body and which is selectively moveable relative to the distal end of the electrode.

Another aspect of the present invention relates to an arc welding apparatus which includes a torch body defining a cooling passageway, and which is coupled with a source of electrical power; a source of compressed gas supplied to the cooling passageway; an electrode having a distal end and which is releasably mounted on the torch body, and electrically coupled with the source of electrical power; and a moveable gas cup which is operable to vary the distance that the distal end of the electrode extends outwardly relative to the gas cup.

Yet a further aspect of the present invention relates to an arc welding apparatus which includes an gas cooled electrically conductive torch body which is coupled with a source of electricity, and wherein the torch body has a first end which is coupled with the source of electricity, and an opposite second end, and wherein a cooling passageway is defined by the torch body, and wherein the cooling passageway has a first gas intake end, and a second gas exhaust end, and wherein the gas intake and exhaust ends are located at the first end of the torch body, and wherein the torch body further defines a weld shielding gas passageway which extends from the first to the second end of the torch body, and an electrode passageway which extends from the second end of the torch body in the direction of the first end of the torch body, and wherein the torch body defines a threaded passageway which is formed in the second end of the torch body and which extends in the direction of the first end of the torch body, and wherein the threaded passageway is substantially coaxially aligned relative to the electrode passageway; a source of compressed gas coupled in fluid flowing relation relative to the gas intake end of the cooling passageway; a source of a weld shielding gas coupled in fluid flowing relation relative to weld shielding gas passageway, and which is delivered to the second end of the torch body and adjacent to the electrode passageway; an electrode which has a proximal end which is received in the electrode passageway, and an opposite, distal end which engages a work object, and wherein the electrode is electrically coupled to the electrically conductive torch body; a collet having a main body with a first end, and an opposite second end, and wherein the main body defines a passageway which extends between the opposite first and second ends thereof, and wherein the electrode is received though the passageway which is defined by the collet; a collet body having a first end which screw threadably mates with the threaded passageway formed in the second end of the torch body, and wherein the collet body defines a passageway which extends therethrough, and which receives the collet, and at least a portion of the electrode, and wherein the passageway which is defined by the collet body is coupled in fluid flowing relation relative to the source of the weld shielding gas, and wherein the weld shielding gas exits the collet body at the second end thereof; a collar mounted on the collet body and which rotatably cooperates, at least in part, with the second end of the torch body, and wherein rotation of the collar in a first direction has the effect of causing the collet and collet body to secure the electrode in a substantially fixed position relative to the torch body, and wherein rotation of the collar in a second direction allows the electrode to be removed from the electrode passageway; and wherein the collar further defines a passageway which extends therethrough; a weld shielding gas delivery assembly which has a main body and opposite first and second ends, and wherein the weld shielding gas delivery assembly defines a centrally disposed passageway which is coupled in fluid flowing relation relative to the source of the weld shielding gas, and wherein the first end of the main body is received, at least in part, in the passageway which is defined by the collar, and wherein the source of weld shielding gas exits the second end of the main body, and wherein the main body is slideably moveable along the passageway which is defined by the collar, and the electrode extends through the passageway as defined by the main body; and a gas cup having a proximal end which is mounted on the main body of the weld shielding gas delivery assembly, and an opposite distal end, and wherein the gas cup is moveable therewith the weld shielding gas delivery assembly, and wherein the gas cup defines a passageway which extends thererthrough and between the proximal and distal ends, and wherein the electrode is received in the passageway which is defined by the gas cup and extends outwardly relative to the distal end thereof, and wherein the gas cup receives the weld shielding gas and directs it to the distal end thereof, and wherein the position of the distal end of the gas cup can be readily adjusted relative to the distal end of the electrode.

These and other aspects of the present invention will be discussed in greater detail hereinafter.

### BRIEF DESCRIPTION OF THE DRAWINGS

Preferred embodiments of the invention are described below with reference to the following accompanying drawings.

FIG. 1 is a perspective view of the arc welding apparatus of the present invention.

FIG. 2 is an exploded, side elevation view of the arc welding apparatus of the present invention.

FIG. 3 is a longitudinal, vertical, sectional view taken from a position along line 3-3 of FIG. 1.

FIG. 4 is a perspective view of a collet body utilized in the arc welding apparatus of the present invention.

FIG. 5 is a longitudinal, vertical, sectional view taken from a position along line 5-5 of FIG. 4.

FIG. 6 is a perspective, side elevation view of a weld shielding delivery assembly or gas lens which is utilized in the present invention.

FIG. 7 is a longitudinal, vertical, sectional view taken from a position along line 7-7 of FIG. 6.

FIG. 8 is a longitudinal, vertical, sectional view of a gas lens collar, and which is utilized in the present invention.

FIG. 9 is a fragmentary, perspective, side elevation view of the torch body which is utilized in the present invention.

FIG. 10 is a transverse, vertical sectional view taken from a position along line 10-10 of FIG. 9.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

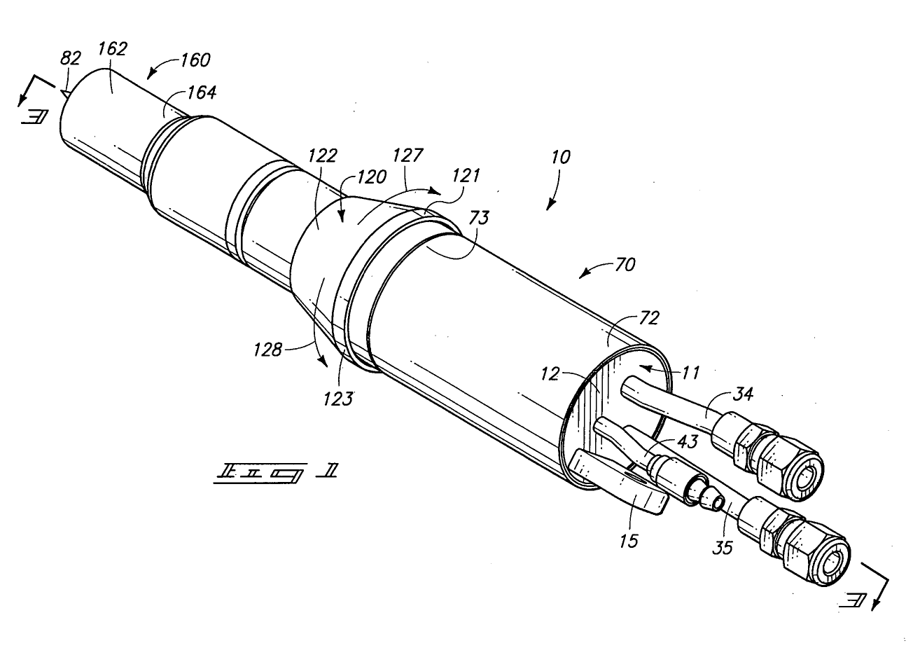

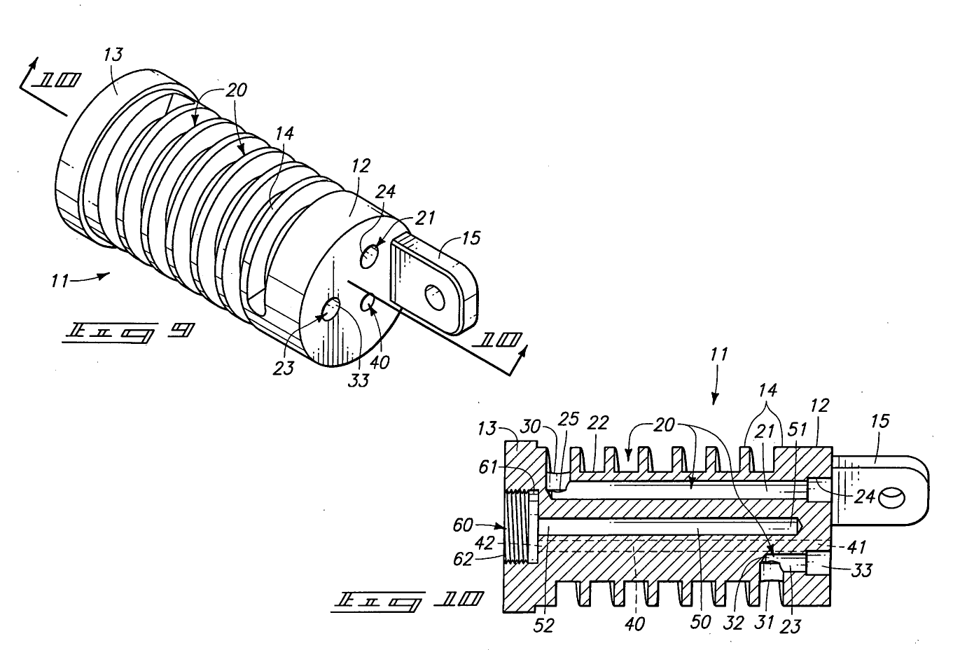

The apparatus of the present invention in generally indicated by the numeral 10 in FIG. 1 and following. As best seen by a study of FIGS. 2, 9 and 10, the arc welding apparatus 10 of the present invention includes an electrically conductive torch body which is generally indicated by the numeral 11. The torch body has a first end 12 and an opposite second end 13 and is further defined by an exterior facing surface 14. Still further, and as seen in FIGS. 9 and 10, a power supply lug 15 is electrically coupled to the first end 12 and extends outwardly therefrom. The lug is operable to be coupled with a source of electricity (not shown), so as to power the arc welding apparatus 10.

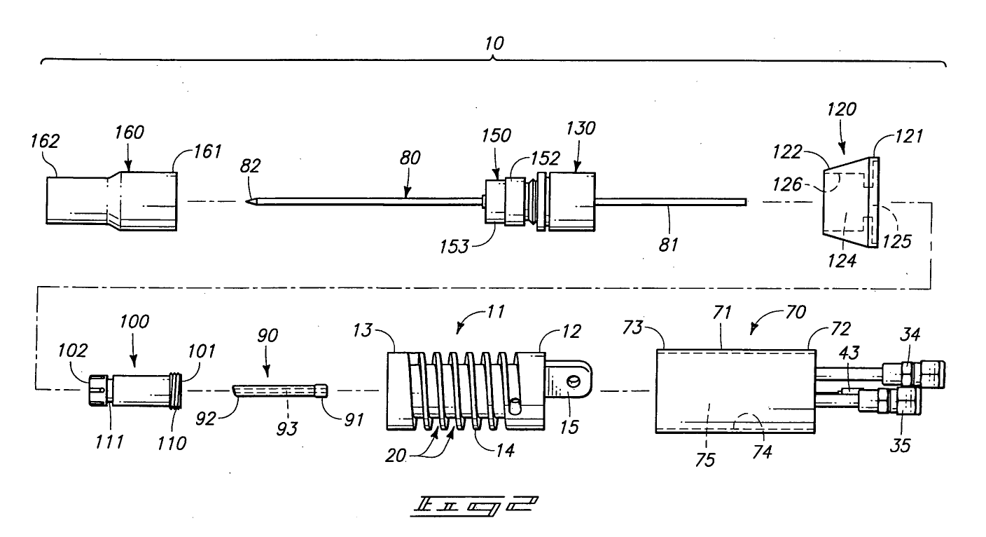

The torch body 11 which comprises a portion of the apparatus 10 defines a gas cooling passageway which is generally indicated by the numeral 20. The gas cooling passageway 20 has a first portion 21 (FIG. 10), a second portion 22, and a third portion 23, all of which are coupled in fluid flowing relation one relative to the other. The first portion 21 of the gas cooling passageway has a first or gas intake end 24, and a second end 25. The first portion 21 extends through the torch body 11 from the first end 12 to a location adjacent the second end 13 thereof. Yet further, the exterior facing surface 14 of the torch body defines, in part, the second portion 22, and which is substantially helically shaped and which extends around the torch body 11, and which is further located intermediate the opposite first and second ends 12 and 13 of the torch body 11. As seen, the first portion 21 of the gas cooling passageway 20 is coupled in fluid flowing relation relative to the second portion 22. Still further, the third portion 23 of the gas cooling passageway 20 has a first end 32, and an opposite second end 33 which comprises a gas exhaust. The third portion of the gas cooling passageway extends from the first end 12 of the torch body 11 and which is coupled in fluid flowing relation relative to the second portion 22 of the gas cooling passageway. As best seen by reference to FIGS. 1 and 3, the apparatus 10 includes a gas intake coupler 34 which is coupled with the first portion 21 of the gas cooling passageway 20, and a gas exhaust coupler 35 which is coupled in fluid flowing relation relative to the third portion 23 thereof. In the arrangement as shown, a source of compressed gas (not shown), and which may comprise ambient air and/or other gases is coupled to the gas intake coupler. Compressed gas is forced through the first, second and third portions of the gas cooling passageway 20 in order to remove heat energy generated by the torch body during welding operations.

Referring now to FIGS. 3 and 10, the torch body 11 further defines a weld shielding purge gas passageway 40 which extends from the first end 12 to the second end 13 thereof. The weld shielding gas passageway has a first end 41 and an opposite second end 42. As seen in FIG. 1, a weld shielding gas coupler 43 is coupled thereto and is coupled in fluid flowing relation relative to a source of a conventional weld shielding gas which is well known in the art. In addition to the foregoing, the torch body defines an electrode passageway generally indicated by the numeral 50. The electrode passageway has a first end 51 and an opposite second end 52. The electrode passageway extends from the second end 13 of the torch body 11 in the direction of the first end 12 thereof. The electrode passageway is operable to receive a conventional tungsten electrode which will be discussed in greater detail hereinafter. Formed in the second end 13 of the torch body 11 is a threaded passageway which is generally indicated by the numeral 60. The threaded passageway has a first end 61 and an opposite second end 62. This passageway 60 extends in the direction of the first end 12 of the torch body and is substantially coaxially aligned relative to the electrode passageway 50. The threaded passageway 60 is coupled in fluid flowing relation relative to the weld shielding gas passageway 40.

As best seen by a study of FIGS. 1 and 2, the apparatus 10 of the present invention includes a torch sleeve which is generally indicated by the numeral 70. The torch sleeve has a main body 71 having a first end 72 and an opposite second end 73. The main body 71 has an interior facing surface 74 which defines a passageway 75 which extends therethrough the torch sleeve 70. As seen in FIGS. 1 and 2, the torch body 11 is telescopingly received in the passageway 75 which is defined by the main body 71. Still further, and as seen in FIG. 3, the torch sleeve 70 defines, at least in part, the gas cooling passageway 20.

Referring now to FIGS. 2 and 3, respectively, the apparatus 10 of the present invention further includes an electrode 80, typically formed of tungsten, and which has a first proximal end 81 which is borne by the torch body 11, and which is electrically coupled with the source of electrical power which is provided to the torch body, and an opposite distal end 82. The tungsten electrode 80, and more specifically the proximal end thereof 81 is received in the electrode passageway 50 and is positioned in a fixed location relative to the torch body 11 by means of a collet which is generally indicated by the numeral 90. The collet, which is well understood in the art, has a first end 91 which is received within the threaded passageway 60, and a second end 92. The collet defines a passageway 93 which extends therethrough. The electrode 80 extends through the passageway 93 as seen most clearly by reference to FIG. 3.

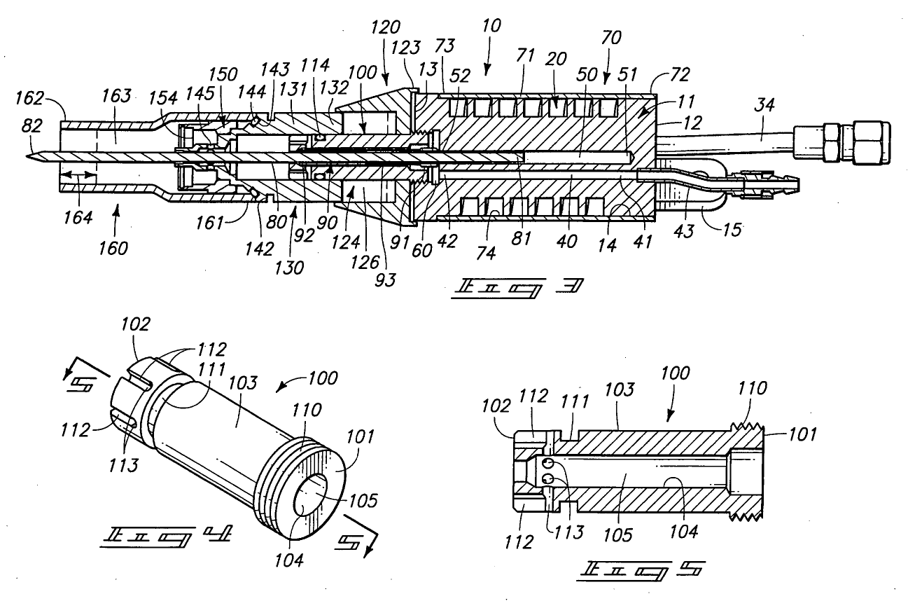

Referring now to FIGS. 3, 4 and 5, the apparatus 10 of the present invention includes a collet body which is generally indicated by the numeral 100. The collet body as seen most clearly by reference to FIG. 3 threadably mates with the second end 13 of the torch body 11 and further receives the collet 90. As seen in the sectional view of FIG. 3, the electrode 80 extends through the collet body 100. Referring now to FIGS. 4 and 5 where the collet body is shown more clearly, the collet body has a first end 101 and an opposite second end 102. Still further, the collet body has an exterior facing surface 103, and an opposite interior facing surface 104 which defines a longitudinally extending passageway 105 which extends between the first and second ends 101 and 102, respectively. The collet body 100 has a threaded portion 110 which is defined by the exterior facing surface 103 at the first end 101 thereof. The threaded portion 110 screw threadably mates with the threaded passageway 60 which is formed in the second end 13 of the torch body 11. As seen most clearly by reference to the longitudinal sectional view of FIG. 5, the longitudinally extended passageway 105 has a first inside diametral dimension as measured at the first end 101 of the collet body, and a second diametral dimension as measured at the second end 102 thereof. The first inside diametral dimension is greater than the second diametral dimension. Still further, the second diametral dimension is smaller than the outside diametral dimension of the collet 90 so as to prevent the collet 90 from passing outside of the longitudinally extending passageway 105. This is seen most clearly by reference to FIG. 3. Still further, a circumscribing channel 111 is formed in the exterior facing surface 103 and is positioned adjacent to the second end 102. A plurality of longitudinally extending passageways 112 are formed in the exterior facing surface 103 at the second end 102. These individual longitudinally extending passageways extend from the second end 102 in the direction of the first end 101 and are positioned intermediate the second end 102 and the circumscribing channel 111. As best seen by the longitudinal sectional view of FIG. 5, a plurality of radially oriented passageways 113 are formed in the second end 102 and which couple the respective longitudinally extending passageways 112 in fluid flowing relation relative to the longitudinally extending passageways 105. In addition to the foregoing, a substantially fluid impervious seal 114 is received in the circumscribing channel 111. This is best seen by reference to the sectional view of FIG. 3. As will be recognized from that same view, the longitudinally extending passageway 105 of the collet body 100 is coupled in fluid flowing relation with the threaded passageway 60. As earlier discussed the threaded passageway 60 is coupled in fluid flowing relation relative to the weld shielding gas passageway 40 which is defined by the torch body 11.

Referring now to FIGS. 1 and 3, the apparatus 10 of the present invention includes a rotatable collar which is generally indicated by the numeral 120, and which is rotatably borne on the second end 13 of the torch body 11, and which further is affixed to the collet body 100. In the arrangement as shown, rotation of the collar 120, in a predetermined direction, allows the electrode 80 to be removed from the collet body 100. In this regard, the collar 120 has a first end 121 and an opposite second end 122. The collar defines a circumscribing flange 123 (FIG. 3) which is formed about the first end 121 and which rotatably matingly cooperates with the second end 13, of the torch body 11. The collar 120 further defines a passageway generally indicated by the numeral 124. The passageway 124, has a first portion 125 (FIG. 2) which receives a portion of the collet body 100, and which is positioned near the threaded portion 110. Still further, the passageway 124 has a second portion 126 which has an inside diametral dimension which is greater than the inside diametral dimension of the first portion 125 and which is further operable to slideably receive the main body of the weld shielding gas delivery assembly which will be discussed below. As should be understood, the collar 120 is affixed to the collet body 100 by brazing or the like. As best seen by a study of FIG. 1, rotation of the collar 120 in a first direction which is indicated by the line labeled 127, has the effect of rotating the collet body 100 so as to permit the electrode 80 to be removed and be replaced. Further, rotation of the collar in a second direction 128, has the effect of advancing collet body 100 within the threaded channel 60 thereby causing the collet 90 to engage the electrode 80 with the result that the electrode 80 and more specifically the distal end thereof 82 is positioned in a fixed location relative to the torch body 11.

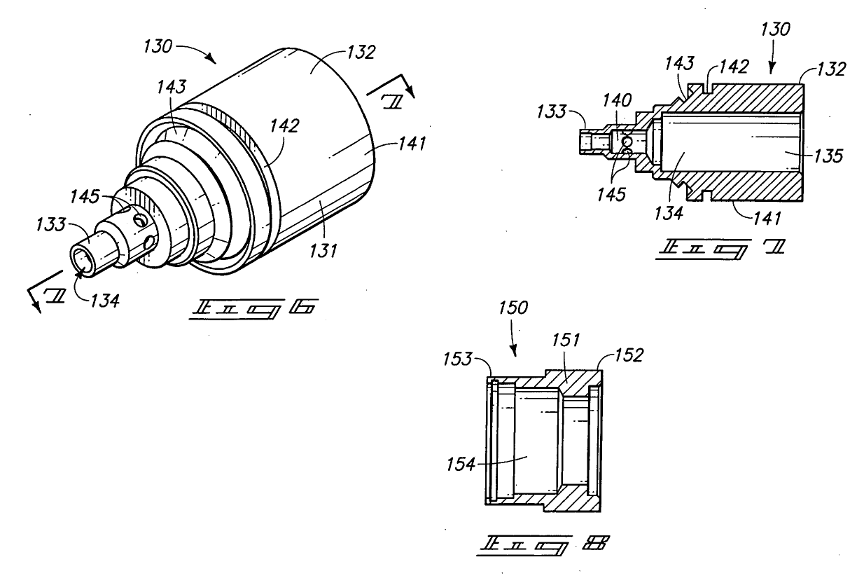

Referring now to FIGS. 3, 6 and 7, the apparatus 10 of the present invention includes a first portion of a weld shielding gas delivery assembly and which is generally indicated by the numeral 130. This first portion of the weld shielding gas delivery assembly 130 is selectively moveable, as will be discussed below, relative to the torch body 11 to achieve the benefits as will be described, hereinafter. The first portion of the weld shielding gas delivery assembly 130 (which is typically referred to in the industry as a “gas lens”) has a main body 131 which has a first end 132, and an opposite second end 133. Still further, the main body defines a longitudinally extending passageway 134 which extends between the first and second ends 132 and 133 and which is coupled in fluid flowing relation relative to the collet body 100. The longitudinally extending passageway 134 has a first portion or segment 135 which has an inside diametral dimension which is slightly greater than the outside diametral dimension of the collet body 100, such that the main body 131 can readily slide therealong the collet body 100. Still further, the longitudinally extending passageway 134 has a second portion or segment 140 which has an inside diametral dimension which is less than the inside diametral dimension of the first portion or segment 135. As seen in FIG. 3, the electrode 80 extends therethrough the longitudinally extending passageway 134, and more specifically through the first and second portions 135 and 140, respectively. The main body 131 has an exterior facing surface 141. A first circumscribing channel 142 is disposed intermediate the first and second ends 132 and 133, respectively. This first circumscribing channel 142 provides a convenient point of contact between the exterior facing surface 141 and an outside force, such as might be applied by a robotic arm or the like, and which would be useful in moving the main body 131 to predetermined locations in spaced relation relative to the torch body 11. Still further, a second circumscribing channel 143 is positioned therebetween the first circumscribing channel 142 and the second end 133 of the main body 131. The second circumscribing channel 143 is operable to receive a fluid impervious seal 144 and which is best seen by reference to FIG. 3. This fluid impervious seal 144 is operable to sealably mate thereagainst a gas cup which will be discussed in greater detail below. As seen most clearly by reference to FIG. 7, a plurality of radially extending passageways 145 are formed in the second end 133 of the main body and which are coupled in fluid flowing relation relative to the second portion 140 of the passageway 134. As should be understood, weld shielding gas, received in the longitudinally extending passageway 134 would pass therealong and out through the radially extending passageways 145 for the purposes which will be described below. As will be seen by reference to FIG. 3, the inside diametral dimension of the second portion 140 is slightly greater than the outside diametral dimension of the electrode 80 which passes therethrough.

Referring now to FIGS. 3 and 8, the apparatus 10 of the present invention includes a second portion of the weld shielding gas delivery assembly 150, and which matingly couples with the first portion of the gas delivery assembly 130. As seen most clearly by references to FIGS. 3 and 8, the second portion of the weld shielding gas delivery assembly, which may be referred to as a “gas lens collar,” includes a main body 151, with a first end 152 which matingly couples in interfitted relation with the main body 131 of the first portion 130 and an opposite, second end 153. A longitudinally extending passageway 154 is formed between the first and second ends 152 and 153. As best seen by reference to FIG. 3, it will be understood that the inside diametral dimension of the longitudinally extending passageway 154 is greater than the outside diametral dimension of the main body 131 when measured at the second end 133 thereof. As should be understood, weld shielding gas which escapes through the radially extending passageways 145 is directed by this second portion of the weld shielding gas delivery assembly 150, into a substantially laminar flow and into the gas cup which is positioned thereabout the second portion 150.

Referring now to FIGS. 1, 2, and 3, it will be seen that the apparatus 10 of the present invention includes a moveable gas cup which is generally indicated by the numeral 160. The gas up has a first or proximal end 161 which is disposed in interfitted fluid sealable relation thereabout the main body 131, of the first portion of the weld shielding gas delivery assembly 130. As seen in FIG. 3, the fluid impervious seal 144 is disposed in sealing relation thereagainst the first or proximal end 161. Still further, the gas cup 160 has an opposite, second, or distal end 162, which as seen in FIG. 3, is disposed in predetermined, spaced relation relative to the distal end 82 of the electrode 80. The gas cup 160 defines a longitudinally extending passageway 163 which extends therebetween the first and second ends 161 and 162, respectively thereby providing a passageway which receives the weld shielding gas which has exited from the second portion of the weld shielding gas delivery assembly 150. As will be recognized from a study of FIG. 3, the gas cup is moveable along a path of travel which is generally indicated by the numeral 164. The moveable gas cup provides advantages over the prior art inasmuch as the amount of the distance between the distal end 82 of the electrode 80 and the distal end of the gas cup 160 can be varied thereby allowing the apparatus 10 to operate in a remote environment such as “hot cells” without adjusting the camera relative to the distal end of the electrode. As was discussed above, the selective movement of the gas cup is implemented by an exterior force which is applied to the main body 131 of the first portion by means of the first circumscribing channel 142. This can be readily performed in remote robotic applications.

### Operation

The operation of the described embodiment of the present invention is believed to be readily apparent and is briefly summarized at this point.

As was described above, the arc welding apparatus 10 of the present invention includes a torch body 11 which is coupled with a source of electrical power, and further an electrode 80 is borne by the torch body and which has a first or proximal end 81 which is electrically coupled with the source of electrical power, and further an opposite second or distal end 82. In the arrangement as seen in FIG. 3, a gas cup 160 is provided and which matingly cooperates with the torch body 11 and which is selectively moveable relative to the distal end 82 of the electrode 80.

More specifically, the arc welding apparatus of the present invention 10 includes a torch body 11 which defines a gas cooling passageway 20, and which is coupled with a source of electrical power. Still further, the apparatus includes a source of compressed gas which is supplied to the cooling passageway. Yet further, an electrode 80 having a distal end 82 is releasably mounted on the torch body, and electrically coupled with the source of electrical power. Yet further, a moveable gas cup 160 is provided and which is operable to vary the distance that the distal end 82 of the electrode 80 extends outwardly relative to the gas cup 160.

In the arc welding apparatus 10 of the present invention, many advantages are provided. In this regard, the arc welding apparatus 10 has a gas cooled electrically conductive torch body 11 which is coupled with a source of electricity. In operation the apparatus of the present invention has a current rating which may equal or exceed 300 amps with a substantially continuous duty cycle based in part upon the source of compressed gas which is employed. The torch body 11 has a first end 12 which is coupled with the source of electricity, and an opposite second end 13. A cooling passageway 70 is defined by the torch body, and has a first gas intake end 24, and a second, gas exhaust end 33. The gas intake and exhaust ends are located at the first end 12 of the torch body 11. Still further, the torch body further defines a weld shielding gas passageway 40 which extends from the first to the second end of the torch body. Still further, an electrode passageway 50 extends from the second end 13 of the torch body 11 in the direction of the first end of the torch body. The torch body 11 defines a threaded passageway 60 which is formed in the second end 13 of the torch body, and which extends in the direction of the first end 12 of the torch body 11. The threaded passageway is substantially coaxially aligned relative to the electrode passageway 50. A source of compressed gas (not shown) is coupled in fluid flowing relation relative to the gas intake end 24 of the cooling passageway 20. Yet further, a source of a weld shielding gas (not shown) is coupled in fluid flowing relation relative to weld shielding gas passageway 40. The weld shielding gas is delivered to the second end 13 of the torch body 11, and adjacent to the electrode passageway 40. An electrode 80 which has a proximal end 81 is received in the electrode passageway 50, and further has an opposite second or distal end 82 which engages a work object. The electrode 80 is electrically coupled to the electrically conductive torch body 11. A collet 90 is provided and which has a main body which has opposite first and second ends 91 and 92. The main body of the collet 90 defines a passageway 93 which extends between the opposite first and second ends thereof. The electrode 80 is received though the passageway 93 which is defined by the collet. A collet body 100 having a first end 101 screw threadably mates with the threaded passageway 60 which is formed in the second end 13 of the torch body 11. The collet body 100 defines a passageway 105 which extends therethrough, and which receives the collet 90, and at least a portion of the electrode 80. The passageway 105 which is defined by the collet body 100 is coupled in fluid flowing relation relative to the source of the weld shielding gas. The weld shielding gas exits the collet body at the second end 102 thereof.

A collar 120 is provided and which is mounted on the collet body 100 and which rotatably cooperates, at least in part, with the second end 13 of the torch body 11. Rotation of the collar in a first direction 127 has the effect of causing the collet 90 and collet body 100 to secure the electrode 80 in a substantially fixed position relative to the torch body 11. Rotation of the collar 12 in a second direction 128 allows the electrode to be removed from the electrode passageway. The collar further defines a passageway 124 which extends therethrough. A weld shielding gas delivery assembly 130 is provided and which has a main body 131 and opposite first and second ends 132 and 133, respectively. The weld shielding gas delivery assembly 130 defines a centrally disposed passageway 134 which is coupled in fluid flowing relation relative to the source of the weld shielding gas. The first end 132 of the main body 131 is received, at least in part, in the passageway 124 which is defined by the collar. The source of weld shielding gas exits the second end 133 of the main body 13. The main body is slideably moveable along the passageway 124 which is defined by the collar 120, and the electrode 80 extends through the passageway 134 as defined by the main body 131. Finally, the apparatus 10 of the present invention includes a gas cup 160 having a proximal end 161 which is mounted on the main body 131 of the weld shielding gas delivery assembly 130, and further has an opposite distal end 162. The gas cup 160 is moveable therewith the weld shielding gas delivery assembly 130. The gas cup 160 defines a passageway 163 which extends therethrough and between the proximal and distal ends thereof. The electrode 80 is receive in the passageway 153 which is defined by the gas cup 160 and extends outwardly relative to the distal end 162 thereof. The gas cup receives the weld shielding gas and directs it to the distal end thereof. The position of the distal end of the gas cup can be readily adjusted in relation to the distal end 162 of the electrode 80.

Therefore it will be seen that the apparatus 10 of the present invention provides many advantages over the prior art gas tungsten arc welding devices which have been utilized in the art heretofore. In particular, in remote operation such as in “hot cells,” the amount of the stick-out distance of the electrode can be readily adjusted. Further, the electrode can be readily replaced by merely twisting the collar 120 in a given direction.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. An arc welding apparatus, comprising:
a torch body which is coupled with a source of electrical power;
an electrode having a proximal end which is borne by the torch body and which is electrically coupled with the source of electrical power, and an opposite distal end; and
a gas cup which matingly cooperates with the torch body and which is selectively moveable relative to the distal end of the electrode.

2. An arc welding apparatus as claimed in claim 1, and wherein the torch body has a first and an opposite second end, and wherein the torch body defines a gas cooling passageway which has a first portion which extends through the torch body from the first end to a location adjacent the second end thereof, and wherein the torch body further has an exterior facing surface, and wherein the exterior facing surface defines a second portion of the gas cooling passageway, and which extends around the torch body and which is further located intermediate the opposite first and second ends of the torch body, and wherein the first portion of the gas cooling passage is coupled in fluid flowing relation relative to the second portion, and wherein the gas cooling passageway has a third portion which extends from the first end of the torch body and is coupled in fluid flowing relation relative to the second portion of the gas cooling passageway.

3. An arc welding apparatus as claimed in claim 2, and wherein the second portion of the gas cooling passageway has a first end which is positioned adjacent to the first end of the torch body, and a second end which is positioned adjacent the second end of the torch body, and wherein the first portion of the gas cooling passageway is coupled fluid flowing relation relative to the second end of the second portion of the gas cooling passageway, and wherein the third portion of the gas cooling passageway is coupled in fluid flowing relation relative to the first end of the second portion of the gas cooling passageway.

4. An arc welding apparatus as claimed in claim 3, and further comprising:
a torch sleeve having a main body with opposite ends, and which defines a passageway which extends between the opposite ends thereof; and wherein the torch body is telescopingly received in the passageway which is defined by the main body, and wherein the torch sleeve defines, in part, the second portion of the gas cooling passageway.

5. An arc welding apparatus as claimed in claim 4, and wherein the torch body further defines a weld shielding gas passageway which extends from the first to the second end of the torch body; and an electrode passageway which extends from the second end of the torch body in the direction of the first end thereof.

6. An arc welding apparatus as claimed in claim 5, and further comprising:
a collet which releasably secures the electrode to the torch body and which locates the distal end of the electrode at a substantially fixed distance from the torch body, and wherein the weld shielding gas passageway is coupled in fluid flowing relation relative to the collet.

7. An arc welding apparatus as claimed in claim 6, and further comprising:
a collet body which threadably mates with the second end of the torch body, and which further receives the collet, and wherein the electrode extends through the collet body.

8. An arc welding apparatus as claimed in claim 7, and wherein the gas cup is coupled in fluid flowing relation relative to the collet body, and further has a proximal and a distal end, and wherein the electrode extends though the gas cup, and the distal end of the electrode is located in spaced relation relative to the distal end of the gas cup, and wherein the gas cup is selectively moveable relative to the collet and torch bodies to vary the distance between the distal end of the gas cup, and distal end of the electrode.

9. An arc welding apparatus as claimed in claim 8, and further comprising:
a weld shielding gas delivery assembly which is slideably borne on the collet body and which is further coupled in fluid receiving relation relative thereto, and wherein the gas cup is matingly coupled to the weld shielding gas delivery assembly.

10. An arc welding apparatus as claimed in claim 9, and further comprising:
a collar which is borne on the second end of the torch body, and which is affixed to the collet body, and wherein rotation of the collar allows the electrode to be removed from the collet body.

11. An arc welding apparatus, comprising:
a torch body defining a gas cooling passageway, and which is coupled with a source of electrical power;
a source of compressed gas supplied to the gas cooling passageway;
an electrode having a distal end and which is releasably mounted on the torch body, and electrically coupled with the source of electrical power; and
a moveable gas cup which is operable to vary the distance that the distal end of the electrode extends outwardly relative to the gas cup.

12. An arc welding apparatus as claimed in claim 11, and wherein the arc welding apparatus has a current rating in excess of at least about 300 amps with a substantially continuous duty cycle.

13. An arc welding apparatus as claimed in claim 11, and wherein the torch body has a first and a second end, and further has an exterior facing surface, and the gas cooling passageway is defined, at least in part by a helical shaped channel which is defined by the exterior facing surface of the torch body, and wherein the helical channel is disposed intermediate the first and second ends of the torch body.

14. An arc welding apparatus as claimed in claim 11, and further comprising:
a torch sleeve having a main body with opposite ends, and which defines a passageway which extends between the opposite ends thereof; and wherein the torch body is telescopingly received in the passageway which is defined by the main body, and wherein the torch sleeve defines, at least in part the gas cooling passageway, and wherein the torch sleeve is fabricated from an electrically conductive substrate.

15. An arc welding apparatus as claimed in claim 11, and wherein the torch body has a first and an opposite second end, and wherein an electrode passageway is formed in the second end of the torch body and which extends internally relative to the torch body in the direction of the first end thereof, and wherein the torch body further defines a weld shielding gas passageway which facilitates the passage of a source of a weld shielding gas from the first end of the torch body to the opposite, second end thereof, and wherein the electrode is received in the electrode passageway and electrically coupled to the torch body.

16. An arc welding apparatus as claimed in claim 11, and wherein the torch body has a first, and an opposite second end, and wherein the arc welding apparatus further comprises:
a collet which defines a substantially longitudinally oriented passageway which extends therethrough, and wherein the electrode is received in, and extends through the longitudinally oriented passageway; and
a collet body defining an internal passageway which extends therethrough, and wherein the collet is received in the internal passageway, and wherein the collet body is threadably coupled to the second end of the torch body, and is operable to secure the electrode in a substantially fixed position relative to the torch body.

17. An arc welding apparatus as claimed in claim 16, and further comprising:
a collar which is borne by, and rotatably cooperates with, the second end of the torch body, and wherein the collar is affixed to the collet body, and wherein rotation of the collar in a first direction secures the electrode in a substantially fixed position relative to the torch body, and rotation of the collar in a second direction allows the electrode to be removed from the torch body.

18. An arc welding apparatus as claimed in claim 17, and wherein the release assembly defines a passageway, and wherein the arc welding apparatus further comprises:
a weld shielding gas delivery assembly which is slideably borne by the collet body and which is received, at least partially, within the passageway which is defined by the collar, and wherein the gas cup is mounted on, and is disposed in fluid flowing relation relative to the weld shielding gas delivery assembly, and wherein the weld shielding gas delivery assembly has an exterior facing surface, and wherein force applied to the exterior facing surface of the weld shielding gas delivery assembly has the effect of positioning the distal end of the electrode at selected distances from the gas cup.

19. An arc welding apparatus as claimed in claim 18, and wherein the torch body, collet body and the weld shielding gas delivery assembly are all coupled in fluid flowing relation together, and wherein a source of a weld shielding gas is delivered to the torch body and is received in the gas cup.

20. An arc welding apparatus, comprising:
a gas cooled electrically conductive torch body which is coupled with a source of electricity, and wherein the torch body has a first end which is coupled with the source of electricity, and an opposite second end, and wherein a gas cooling passageway is defined by the torch body, and wherein the gas cooling passageway has a first gas intake end, and a second gas exhaust end, and wherein the gas intake and exhaust ends are located at the first end of the torch body, and wherein the torch body further defines a weld shielding gas passageway which extends from the first to the second end of the torch body, and an electrode passageway which extends from the second end of the torch body in the direction of the first end of the torch body, and wherein the torch body defines a threaded passageway which is formed in the second end of the torch body and which extends in the direction of the first end of the torch body, and wherein the threaded passageway is substantially coaxially aligned relative to the electrode passageway;
a source of compressed gas coupled in fluid flowing relation relative to the gas intake end of the cooling passageway;
a source of a weld shielding gas coupled in fluid flowing relation relative to weld shielding gas passageway, and which is delivered to the second end of the torch body and adjacent to the electrode passageway;
an electrode which has a proximal end which is received in the electrode passageway, and an opposite distal end which engages a work object, and wherein the electrode is electrically coupled to the electrically conductive torch body;
a collet having a main body with a first end, and an opposite second end, and wherein the main body defines a passageway which extends between the opposite first and second ends thereof, and wherein the electrode is received though the passageway which is defined by the collet;
a collet body having a first end which screw threadably mates with the threaded passageway formed in the second end of the torch body, and wherein the collet body defines a passageway which extends therethrough, and which receives the collet, and at least a portion of the electrode, and wherein the passageway which is defined by the collet body is coupled in fluid flowing relation relative to the source of the weld shielding gas, and wherein the weld shielding gas exits the collet body at the second end thereof;
a collar mounted on the collet body and which rotatably cooperates, at least in part, with the second end of the torch body, and wherein rotation of the collar in a first direction has the effect of causing the collet and collet body to secure the electrode in a substantially fixed position relative to the torch body, and wherein rotation of the collar in a second direction allows the electrode to be removed from the electrode passageway; and wherein the collar further defines a passageway which extends therethrough;
a weld shielding gas delivery assembly which has a main body and opposite first and second ends, and wherein the weld shielding gas delivery assembly defines a centrally disposed passageway which is coupled in fluid flowing relation relative to the source of the weld shielding gas, and wherein the first end of the main body is received, at least in part, in the passageway which is defined by the collar, and wherein the source of weld shielding gas exits the second end of the main body, and wherein the main body is slideably moveable along the passageway which is defined by the collar, and the electrode extends through the passageway as defined by the main body; and
a gas cup having a proximal end which is mounted on the main body of the weld shielding gas delivery assembly, and an opposite distal end, and wherein the gas cup is moveable therewith the weld shielding gas delivery assembly, and wherein the gas cup defines a passageway which extends thererthrough and between the proximal and distal ends, and wherein the electrode is received in the passageway which is defined by the gas cup and extends outwardly relative to the distal end thereof, and wherein the gas cup receives the weld shielding gas and directs it to the distal end thereof, and wherein the position of the distal end of the gas cup can be readily adjusted relative to the distal end of the electrode.

21. An arc welding apparatus as claimed in claim 20, and which further comprises:
a torch sleeve which defines a passageway which extends therethrough, and wherein the torch body is received, at least in part in the passageway.

22. An arc welding apparatus as claimed in claim 20, and wherein the arc welding apparatus has a current rating in excess of about 300 amps with a substantially continuous duty cycle.

23. An arc welding apparatus as claimed in claim 20, and wherein the weld shielding gas delivery assembly includes a gas lens portion, and a gas lens collar which cooperates with the gas lens portion, and wherein the gas lens collar is received in the passageway which is defined by the gas cup.

24. An arc welding apparatus as claimed in claim 20, and wherein the weld shielding gas delivery assembly has an exterior facing surface, and wherein force applied to the exterior facing surface of the weld shielding gas delivery assembly adjusts the position of the distal end of the gas cup relative to the distal end of the electrode.
